(19) United States
(12) Patent Application Publication
(10) Pub. No.: US 2025/0219989 A1
(43) Pub. Date: Jul. 3, 2025

(54) 5G VIRTUAL INTERNET PROTOCOL (VIP) AUDIT IN THE CLOUD

(71) Applicants: DISH Wireless L.L.C., Englewood, CO (US); DISH Network Technologies India Private Limited, Bangalore (IN)

(72) Inventors: Kenneth William Weber, JR., Littleton, CO (US); Ankesh Arora, Bangalore (IN); Nirajkanti Samal, Bangalore (IN)

(21) Appl. No.: 18/398,002

(22) Filed: Dec. 27, 2023

(51) Int. Cl. H04L 61/5046; H04L 61/5007; H04L 67/1001; H04L 101/618

(52) U.S. Cl. CPC H04L 61/5046; H04L 61/5007; H04L 67/1001; H04L 2101/618

(57) ABSTRACT

A system having a remote data center that broadcasts, to a various data centers, a cluster of software and a start instruction. The start instruction commands each of the various data centers to execute a master application when a processor in each of the various data centers extracts the master application from the cluster of software. The processor can extract an active pod and a standby pod from the cluster of software and determine whether or not an IP address conflict exists between the IP address of the active pod and the IP address of the standby pod.

### BACKGROUND

A 5G (fifth generation) network is a wireless network infrastructure that provides significant technological advancements in comparison with previous network infrastructures such as 1G, 2G, 3G, and 4G LTE. These technological advancements resulting from a 5G network infrastructure include improvements in speed, capacity, latency, and connectivity as compared to predecessor network infrastructures.

### DRAWINGS

FIG. 1 illustrates an example of a telecommunications system.

FIG. 2 illustrates an example of a radio access network.

FIG. 3 illustrates an example of a functional architecture for a core network data center.

FIG. 4A illustrates an example of geographic regions in the telecommunications system.

FIG. 4B illustrates an example of a distributed cloud computing environment.

FIG. 4C illustrates an example of the distributed cloud computing environment.

FIG. 5 is an example data center cluster group.

FIG. 6A is a flowchart that illustrates an example of processing in the distributed cloud computing environment.

FIG. 6B is a flowchart that illustrates an example of Virtual Internet Protocol (VIP) Audit processing.

### DETAILED DESCRIPTION OF THE INVENTION

In a communications network such as a 5G network, an Internet Protocol (IP) address is a numerical identifier that is assigned to the devices and network functions that are connected to the network. The IP address uniquely identifies each device and network function. By uniquely identifying each device and network function on the network, IP addresses can facilitate data communication between the devices and network functions.

Presently, Internet Protocol version 4 (IPv4) and Internet Protocol version 6 (IPv6) are two of the predominant types of IP address formats. Internet Protocol version 4 (IPv4) IP addresses are expressed as four sets of numbers separated by periods (e.g., 196.154.0.1). Internet Protocol version 6 (IPv6) IP addresses are expressed as eight sets of numbers separated by colons (e.g., 2007:0db3:63a3:0000:0000:4b3e:0271:6445).

To effectively facilitate data communication between the devices and network functions, each of the devices and network functions on the network must be assigned a unique IP address. However, IP address conflicts can arise when two or more devices and/or network functions on the network are assigned the same IP address, which can lead to disruptions in data communication that could impact the overall performance of the network. Accordingly, there is a need in the art for an improved infrastructure for Virtual Internet Protocol (VIP) Auditing.

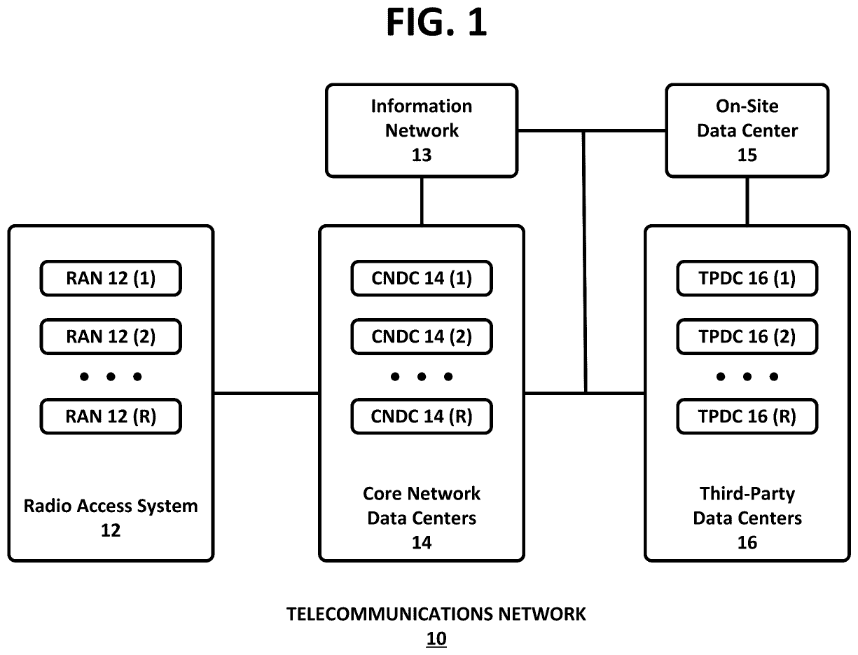

FIG. 1 illustrates an example of a telecommunications network 10. Components of the telecommunications network 10 may include a radio access system 12, an information network 13, core network data centers 14, an on-site data center 15, and third-party data centers 16. The radio access system 12, the core network data centers 14, and the on-site data center 15 may be part of a public land mobile network that provides publicly-available mobile telecommunications services.

As will be explained in detail, the components of the radio access system 12 may include individual radio access networks (RAN) 12 having RAN 12 (1) through RAN 12 (R), with “R” being an integer number greater than 1. The core network data centers 14 may include various core network data centers (CNDC) 14 having CNDC 14 (1) through CNDC 14 (R). The third-party data centers 16 may include various third-party data centers (TPDC) 16 having TPDC 16 (1) through TPDC 16 (R).

### Radio Access System 12

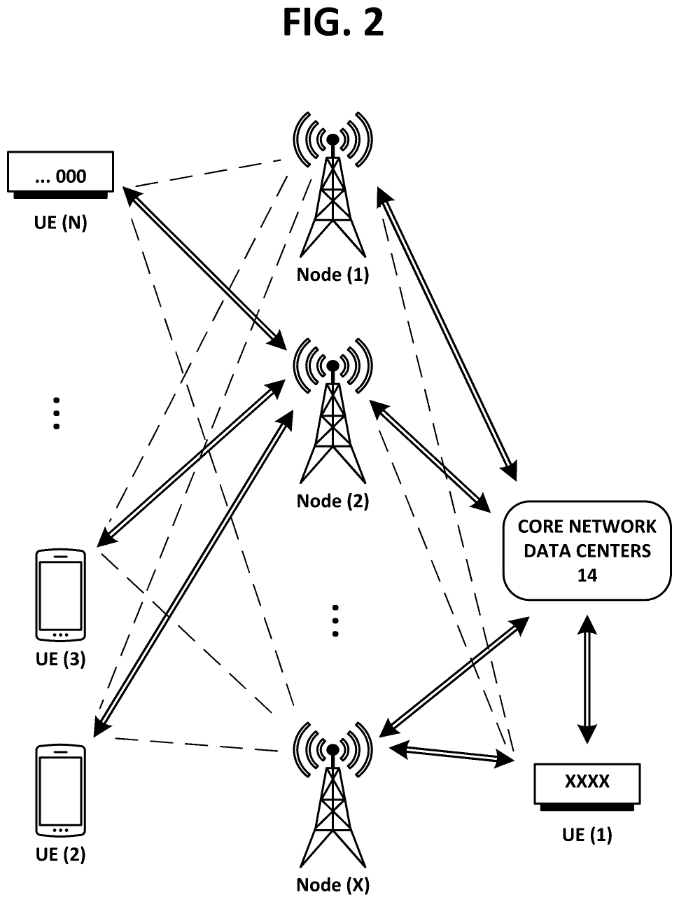

FIG. 2 is an example of any radio access network RAN 12 (1) through RAN 12 (R) in the radio access system 12. Components of any RAN 12 (1) through RAN 12 (R) may include a number of nodes having node (1) through node (X), with “X” being an integer number greater than 1. Each node (1) through node (X) in any RAN 12 (1) through RAN 12 (R) may be individually identifiable by a unique Internet Protocol (IP) address. An IP address for any node (1) through node (X) differs from the IP address for any other node (1) through node (X).

As will be explained in detail, each node (1) through node (X) may provide communication coverage for a respective geographic coverage area in a geographic region. For simplicity and ease of understanding, the FIG. 2 shows a case in which only three nodes are present in the radio access network. However, the number of nodes in the radio access network may vary depending on the architecture of the radio access system 12. For example, any RAN 12 (1) through RAN 12 (R) may typically include more than three nodes, if not hundreds or thousands of nodes. Each node (1) through node (X) may electronically communicate directly or indirectly with any other node (1) through node (X).

FIG. 2 illustrates user equipment (UE) having UE (1) through UE (N), with “N” being another integer number greater than 1. User equipment UE (1) through UE (N) may be a mobile electronic device. Any user equipment UE (1) through UE (N) may be a stationary electronic device. User equipment UE (1) through UE (N) may be a tablet, a telephone, a smartphone, an appliance, a modem, a laptop, a computing device, a television set, a set-top box, a digital video recorder (DVR), a wireless access point, a router, a gateway, a network switch, a set-back box, a control box, a television converter, a television recording device, a media player, an Internet streaming device, a mesh network node, and/or any other electronic equipment that is configured to wirelessly communicate with any node (1) through node (X). The total amount of UEs in the radio access system 12 may vary depending on the number of UEs that are connected to the radio access system 12. For simplicity and ease of understanding, the FIG. 2 shows a case in which only four UEs are present in any RAN 12 (1) through RAN 12 (R). However, any RAN 12 (1) through RAN 12 (R) may accommodate more than four UEs, if not hundreds or thousands of UEs. Each user equipment UE (1) through UE (N) in any RAN 12 (1) through RAN 12 (R) may be individually identifiable by a unique IP address. An IP address for any UE (1) through node (N) differs from the IP address for any other UE (1) through node (N).

As illustrated in FIG. 2, node (1) through node (X) are each an electronic apparatus that may facilitate wireless communication between a core network data center CNDC 14 (1) through CNDC 14 (R) and any user equipment UE (1) through UE (N). To facilitate wireless communication between user equipment UE (1) through UE (N) and the radio access system 12, any node (1) through node (X) may wirelessly connect any user equipment UE (1) through UE (N) to the various core network data centers CNDC 14 (1) through CNDC 14 (R).

A node (1) through node (X) may electronically communicate with more than one user equipment UE (1) through UE (N). Any user equipment UE (1) through UE (N) may electronically communicate directly with the core network data centers 14 by wire or wirelessly. Any node (1) through node (X) may be of a same radio access type or may be of different radio access type as any other node (1) through node (X). Any node (1) through node (X) may be a cell tower, a mobile switching center, a base station, a macrocell, a microcell, a picocell, a femtocell, and/or other component that enables the transmission of signals between core network data centers 14 and any user equipment UE (1) through UE (N).

### Information Network 13

The information network 13 may be a data network that allows for the distribution of information. The information network 13 may include a public or private data network. The public or private data network may comprise or be part of a data bus, a wired or wireless information network, a public switched telephone network, a satellite network, a local area network (LAN), a wide area network (WAN), and/or the Internet. The information network 13 may facilitate the transfer of information between the multiple devices in the form of packets. Each of these packets may comprise small units of data.

Components of the information network 13 may comprise a combination of routers, switches, and servers. Each of the routers, switches, and servers may be individually identifiable by a unique IP address. The respective IP address for any of the routers, switches, and servers may differ from the IP address for any other routers, switches, and servers in the information network 13. The information network 13 may comprise hundreds or thousands of routers, switches, and servers. Each of the routers, switches, and servers may electronically communicate with any others of the routers, switches, and servers.

Servers on the information network 13 may be indirectly accessible by any user equipment UE (1) through UE (N). A server may be a virtual server, a physical server, or a combination of both. The physical server may be hardware in a communications network data center. Each communications network data center may be a facility that is sited in a building at a geographic location. Each facility may contain the routers, switches, servers, and other hardware equipment required for processing electronic information and distributing the electronic information throughout the information network 13. The virtual server may be in the form of software that is running on a server in the communications network data center.

### Core Network Data Centers 14

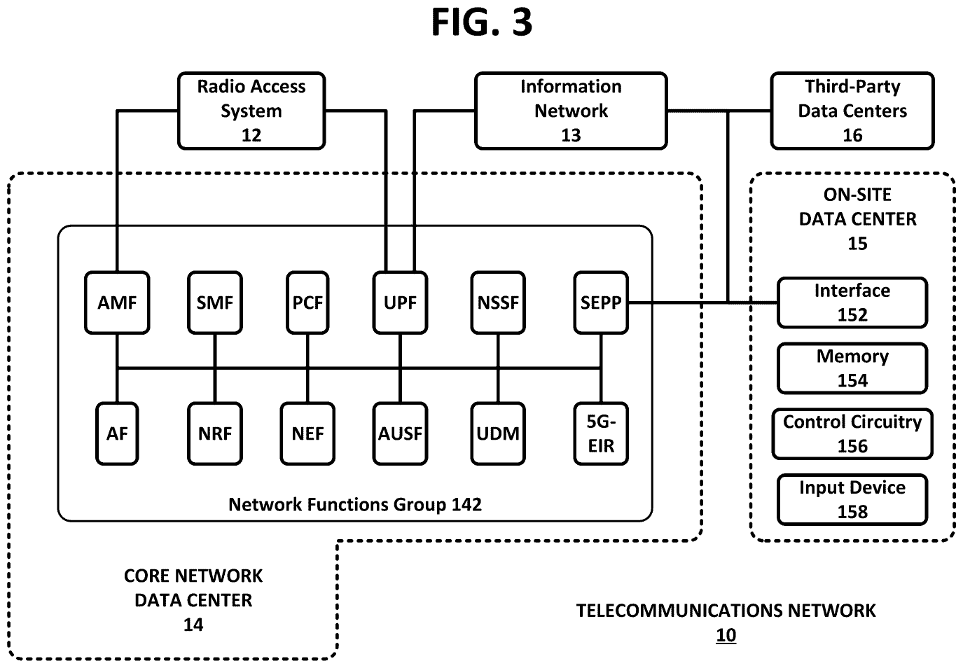

The core network data centers 14 may include various core network data centers (CNDC) 14 having CNDC 14 (1) through CNDC 14 (R). FIG. 3 illustrates an example of a functional architecture for a core network data center 14. Components of the core network data center 14 may comprise a combination of routers, switches, and servers. Each of the routers, switches, and servers may be individually identifiable by a unique IP address. The respective IP address for any of the routers, switches, and servers may differ from the IP address for any other routers, switches, and servers in the core network data center 14.

The core network data center 14 may comprise hundreds or thousands of routers, switches, and servers. Each of the routers, switches, and servers may electronically communicate with any others of the routers, switches, and servers. A servers on the core network data center 14 may be a virtual server, a physical server or a combination of both. The virtual server may be in the form of software that is running on a server in a core network data center. The physical server may be hardware in a core network data center 14. Each core network data center 14 may be a facility that is sited in a building at a geographic location. The facility may contain the routers, switches, servers, and other hardware equipment required for processing electronic information and distributing the electronic information throughout the core network 13.

The user equipment UE (1) through UE (N), when accessing the servers, may receive downloadable information from the servers. This downloadable information may include, but is not limited to, graphics, media files, software, scripts, documents, live streaming media content, emails, and text messages. The servers may provide a variety of services to user equipment UE (1) through UE (N). The variety of services may include web browsing, media streaming, text messaging, and online gaming.

A Telecommunications Service Provider may own, operate, maintain and upgrade one or more of the core network data centers 14. The Telecommunications Service Provider may be a company, business, an organization, and/or another entity. Core network data centers CNDC 14 (1) through CNDC 14 (R) are each an individual and distinct telecommunications network that may deliver a variety of services to any user equipment UE (1) through UE (N). These services may include, but are not limited to, voice calls, text messaging, internet access, video conferencing, multimedia content delivery, and other services.

As illustrated in FIG. 3, the core network data center 14 may comprise a network functions group 142 that enables a core network data center 14 to control the routing of information throughout the telecommunications network 10. Interoperability between the network functions of network functions group 142 may exist. The network functions group 142 may be software-based, with each of the network functions group 142 being a combination of small pieces of software code called microservices.

The core network data center 14 may comprise various network functions group 142. Several of the network functions group 142 may control and manage the core network data centers 14. FIG. 3 illustrates some of the network functions in the network functions group 142.

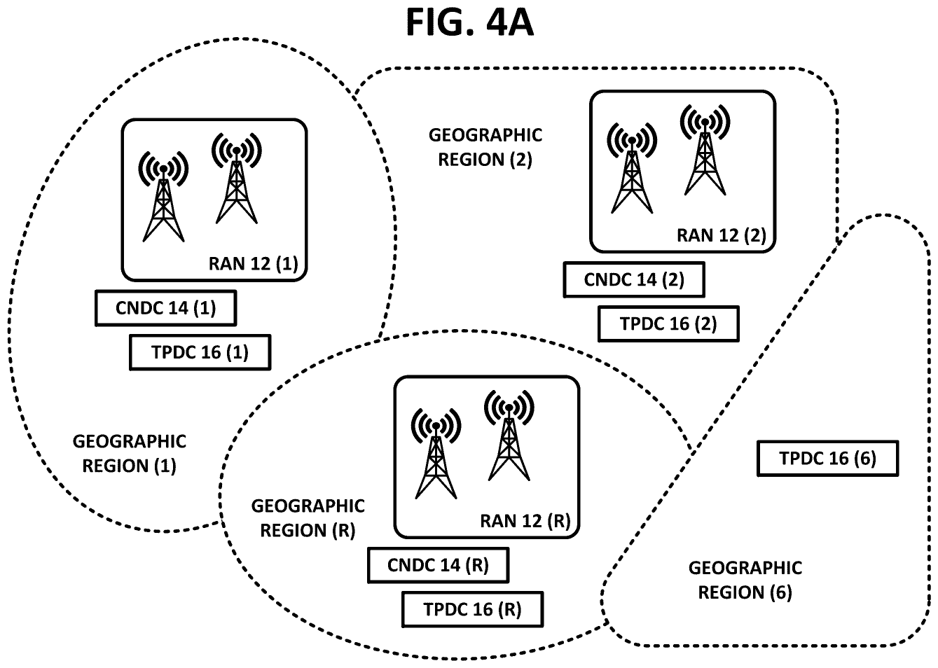

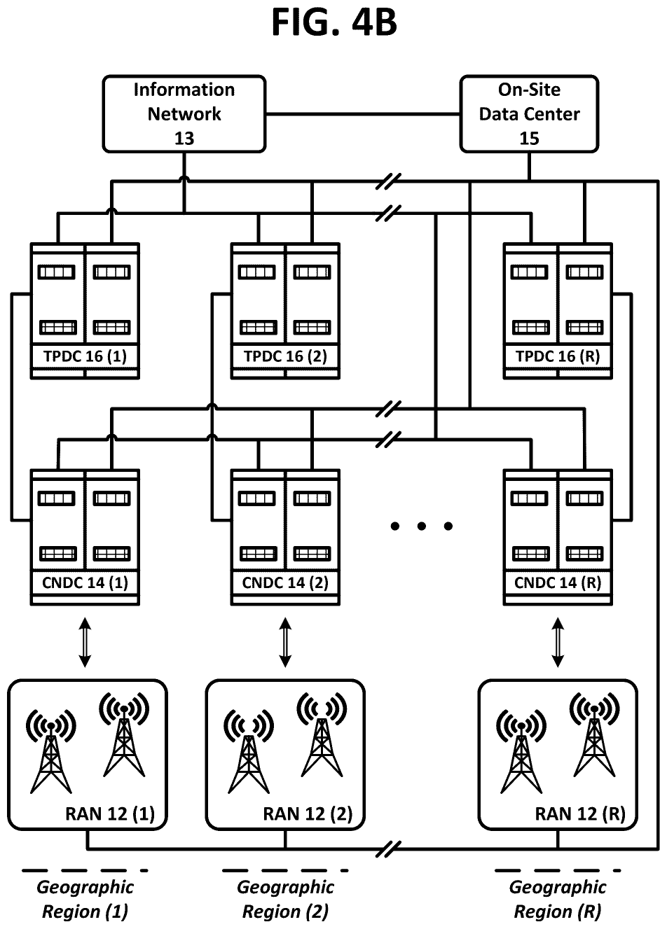

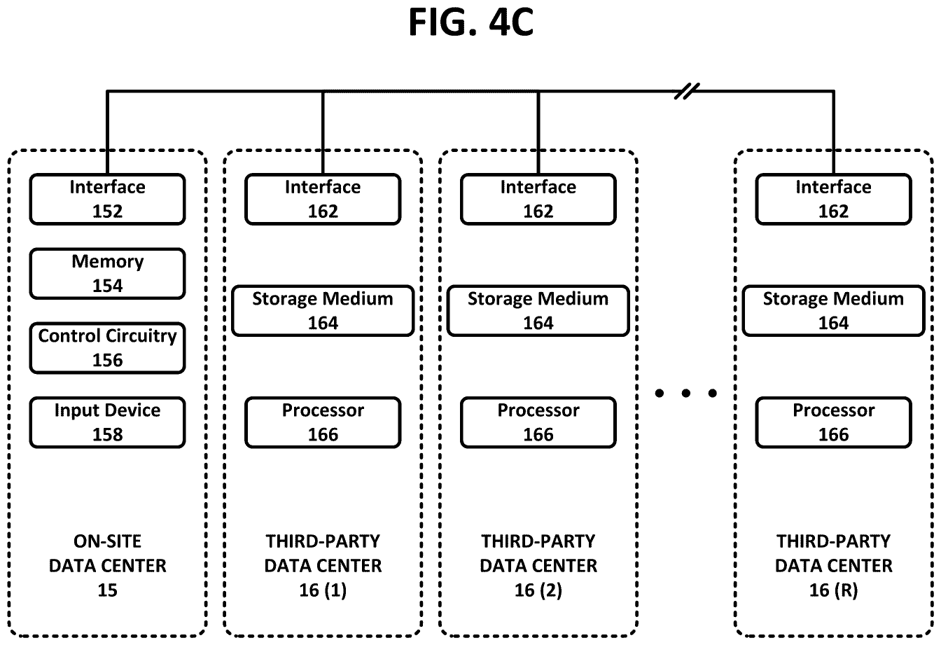

The Access and Mobility Management Function (AMF) is responsible for the management of communication between the telecommunications network 10 and user equipment such as user equipment UE (1) through UE (N). This management may include the authorization of access to the telecommunications network 10 by any user equipment UE (1) through UE (N). Other responsibilities for the AMF may include mobility-related functions such as handover procedures that allow any user equipment UE (1) through UE (N) to remain in communication with the telecommunications network 10 while traversing throughout any geographic region (1) through graphic region (R) in the example of FIG. 4A.

The Authentication Server Function (AUSF) may primarily manage the authentication processes and procedures for ensuring that any user equipment UE (1) through UE (N) is authorized to connect with and access the core network data centers 14.

The User Plane Function (UPF) is responsible for establishing a data path between the information network 13 and any user equipment UE (1) through UE (N). When any RAN 12 (1) through RAN 12 (R) transfers packets of information between the core network data centers 14 and any user equipment UE (1) through UE (N), the UPF may manage the routing of the packets between the radio access system 12 and the information network 13.

The Session Management Function (SMF) is primarily responsible for establishing, modifying, and terminating sessions for any user equipment UE (1) through UE (N). A session is the presence of electronic communication between the core network data centers 14 and the respective user equipment UE (1) through UE (N). The SMF may manage the allocation of an IP address to any user equipment UE (1) through UE (N).

The Unified Data Management (UDM) maintains information for subscribers to the core network data centers 14. A subscriber may include an entity who is subscribed to a service that the core network data centers 14 provides. The entity may be a person that uses any user equipment UE (1) through UE (N). The entity be any user equipment UE (1) through UE (N). The information for the subscribers may include, but is not limited to, the identities of the subscribers, the authentication credentials for the subscribers, and any service preferences that the core network data centers 14 is to provide to the subscribers.

The Network Slice Selection Function (NSSF) is primarily responsible for selecting and managing network slices. Network slicing is the creation of multiple virtual networks within a core network data center 14. Each virtual network is a network slice. When selecting a network slice, the NSSF may determine which virtual network is best suited for a particular service or application. When managing the network slice, the NSSF may allocate available network resources of the core network data center 14 to the network slice. These network resources may include bandwidth, processing power, and other resources of the core network data center 14.

Application Function (AF) is responsible for managing application services within the core network data center 14. For example, the AF may support network slicing by managing and controlling application services within each network slice.

The Policy Control Function (PCF) is responsible for establishing, terminating, and modifying bearers. A bearer is a virtual a communication channel between the core network data center 14 and any user equipment UE (1) through UE (N). This communication channel is a path through which data is transferred between the core network data center 14 and any user equipment UE (1) through UE (N).

The Network Exposure Function (NEF) is responsible for enabling interactions between the core network data center 14 and authorized services and/or applications that are external to the core network data center 14. These interactions, when enabled by the NEF, may lead to the development of innovations that may improve the capabilities of the core network data center 14.

The NF Repository Function (NRF) maintains profiles for each of the network functions group 142 in the core network data center 14. The profiles for a network function may include information about capabilities, supported services, and other details that are relevant for the network function.

The 5G-Equipment Identity Register (5G-EIR) is a database that stores information about each user equipment UE (1) through UE (N) that is connected to the core network data center 14. This information may include unique identifiers for identifying user equipment UE (1) through UE (N). A unique identifier may be an International Mobile Equipment Identity (IMEI) number.

A Security Edge Protection Proxy (SEPP) facilitates the secure interconnection between the core network data center 14 and other networks.

Each of the network functions group 142, databases, and proxies may be individually identifiable by a unique IP address. A network operator may assign the IP addresses for the network functions group 142. The respective IP address for any of the network functions in the network functions group 142 may differ from the IP address for any other network function, database, and/or proxy in the core network data center 14. Each of the network functions, databases, and proxies may electronically communicate with any others of the network functions, databases, and proxies in the core network data center 14. However, the IP addresses for the network functions, databases, and proxies in the core network data center 14 are typically private IP addresses that are not publicly accessible.

As will be explained in detail, the core network data centers 14 may communicate electronically with the information network 13, the on-site data center 15, the third-party data centers 16, any radio access network RAN 12 (1) through RAN 12 (R), any node (1) through node (X), and any user equipment UE (1) through UE (N).

### On-Site Data Center 15

The on-site data center 15 may be a data center that is owned by a single entity or leased exclusively by the single entity. The on-site data center 15 may be responsible for monitoring and managing the overall operation of the telecommunications network 10. The on-site data center 15 may contain routers, switches, servers, and other hardware equipment. The routers, switches, servers, and other hardware equipment in the on-site data center 15 may be identifiable respectively by a unique IP address. The on-site data center 15, itself, may be identifiable by another unique IP address. The IP address for on-site data center 15 may differ from any other IP address in the telecommunications network 10.

The on-site data center 15 may be located physically in a facility that is sited at one or more geographic locations and may include a building, dwelling, and/or any portion of a structure that is owned, leased, or controlled by the entity. The entity may be a business, a company, an organization, and/or an individual. The entity may assist in the operation of the on-site data center 15. As illustrated in FIG. 3, the on-site data center 15 may include an interface 152, memory 154, control circuitry 156, and an input device 158.

The interface 152 may include electronic circuitry that allows the on-site data center 15 to electronically communicate by wire or wirelessly with the information network 13 and the third-party data centers 16. The interface 152 may encrypt information prior to electronically communicating the encrypted information to the information network 13. The interface 152 may also encrypt the information prior to electronically communicating the encrypted information to any of the third-party data centers 16. The interface 152 may decrypt information that the interface 152 receives from the information network 13 and the third-party data centers 16. As illustrated in FIG. 3, the interface 152 may electronically connect the on-site data center 15 with the SEPP of the core network data centers 14.

Memory 154 may be a non-transitory processor readable or computer readable storage medium. Memory 154 may comprise read-only memory (“ROM”), random access memory (“RAM”), other non-transitory computer-readable media, or a combination thereof. In some examples, memory 154 may store firmware. Memory 154 may be any electronic, magnetic, optical, or other physical storage device that stores executable instructions and/or data. Memory 154 may store filters, rules, data, or a combination thereof. Memory 154 may store software for the on-site data center 15. The software for the on-site data center 15 may include program code. The program code may include program instructions that are readable and executable by the control circuitry 156, also referred to as machine-readable instructions.

As will be explained in detail, the control circuitry 156 may control the functions and circuitry of the on-site data center 15. The control circuitry 156 may be implemented as any suitable processing circuitry including, but not limited to at least one of a microcontroller, a microprocessor, a single processor, and a multiprocessor. The control circuitry 156 may include at least one of a video scaler integrated circuit (IC), an embedded controller (EC), a central processing unit (CPU), a graphics processing unit (GPU), an accelerated processing unit (APU), an application specific integrated circuit (ASIC), field programmable gate arrays (FPGA), or the like, and may have a plurality of processing cores.

The input device 158 may include any apparatus that permits a person to interact with the on-site data center 15. The apparatus may include a keyboard, a touchscreen, and/or a graphical user interface (GUI). The apparatus may include a voice user interface (VUI) that enables interaction with the on-site data center 15 through voice commands. The apparatus may comprise mechanical switches, buttons, and knobs. The input device 158 may include any other apparatus, circuitry and/or component that permits the person to interact with the on-site data center 15. The interface 152 may receive information from the input device 158.

### Third-Party Data Centers 16

Third-party data centers 16 are data centers that are owned, maintained, and upgraded by one or more third-party service providers. A third-party service provider is an entity other than the entity that owns or leases the on-site data center 15. For a fee or other valuable consideration, the third-party service provider may permit access to any of the third-party data centers 16. Each of the third-party data centers 16 may be sited physically at a location other than the location where the on-site data center 15 is sited.

### Distributed Cloud Computing Environment

As illustrated in FIG. 4A, the telecommunications system 10 may be partitioned into a number of geographic regions having geographic region (1) through geographic region (R), with “R” being an integer number greater than 1.

Geographic region (1) may include a radio access network RAN 12 (1), a core network data center CNDC 14 (1), and a third-party data center TPDC 16 (1). The radio access network RAN 12 (1) may provide communication coverage for the telecommunications system 10 in the geographic region (1). The core network data center CNDC 14 (1) may deliver a variety of services to the user equipment user equipment UE (1) through UE (N) that are in electronic communication with RAN (1). The interface 152 may communicate electronically with the third-party data center TPDC 16 (1).

Geographic region (2) may include a radio access network RAN 12 (2), a core network data center CNDC 14 (2), and a third-party data center TPDC 16 (2). The radio access network RAN 12 (2) may provide communication coverage for the telecommunications system 10 in the geographic region (2). The core network data center CNDC 14 (2) may deliver a variety of services to the user equipment UE (2) through UE (N) that are in electronic communication with RAN (2). The interface 152 may communicate electronically with the third-party data center TPDC 16 (2).

Geographic region (R) may include a radio access network RAN 12 (R), a core network data center CNDC 14 (R), and a third-party data center TPDC 16 (R). The radio access network RAN 12 (R) may provide communication coverage for the telecommunications system 10 in the geographic region (R). The core network data center CNDC 14 (R) may deliver a variety of services to the user equipment UE (R) through UE (N) that are in electronic communication with RAN (R). The interface 152 may communicate electronically with the third-party data center TPDC 16 (R).

FIG. 4B illustrates an example of a distributed cloud computing environment. The hardware infrastructure for the distributed cloud computing environment may include cables, antennas, and physical other components that enable the transmission and reception of communications traffic between, the information network 13, on-site data center 15, any core network data center CNDC 14 (1) through CNDC 14 (R), and any third-party data center TPDC 16 (1) through TPDC 16 (R).

As illustrated in FIG. 4B, the radio access network RAN 12 (1) may electronically communicate bi-directionally with the core network data center CNDC 14 (1). The CNDC 14 (1) may electronically communicate bi-directionally with the third-party data center TPDC 16 (1) and the RAN (1).

The radio access network RAN 12 (2) may electronically communicate bi-directionally with the core network data center CNDC 14 (2). The CNDC 14 (2) may electronically communicate bi-directionally with the third-party data center TPDC 16 (2) and the RAN (2).

The radio access network RAN 12 (R) may electronically communicate bi-directionally with the core network data center CNDC 14 (R). The CNDC 14 (R) may electronically communicate bi-directionally with the third-party data center TPDC 16 (R) and the RAN (R).

FIG. 4B additionally illustrates that the information network 13 may electronically communicate bi-directionally with the on-site data center 15, any CNDC 14 (1) through CNDC 14 (R), and any of the third-party data centers TPDC 16 (1) through TPDC 16 (R). The on-site data center 15 may electronically communicate bi-directionally with the information network 13, any CNDC 14 (1) through CNDC 14 (R), and any of the third-party data centers TPDC 16 (1) through TPDC 16 (R).

The on-site data center 15 may perform data center processing for the telecommunications system 10 that is consistent with the present disclosure. As will be explained in detail, the status monitoring may include VIP Auditing of the telecommunications system 10.

FIG. 4C illustrates that each of the third-party data centers TPDC 16 (1) through TPDC 16 (R) may include an interface 162, a storage medium 164 and a processor 166.

As illustrated in FIG. 4C, the interface 152 of the on-site data center 15 may facilitate communication with the interface 162 of any of the third-party data centers TPDC 16 (1) through TPDC 16 (R) by wire or wirelessly.

The storage medium 164 may be a non-transitory processor readable or computer readable storage medium. The storage medium 164 may store filters, rules, data, or a combination thereof. The storage medium 164 may comprise read-only memory (“ROM”), random access memory (“RAM”), other non-transitory computer-readable media, or a combination thereof. In some examples, the storage medium 164 may store firmware. The storage medium 164 may store software for any of the third-party data centers TPDC 16 (1) through TPDC 16 (R). The software for any of the third-party data centers TPDC 16 (1) through TPDC 16 (R) may include program code. The program code may include program instructions that are readable and executable by the processor 166, also referred to as machine-readable instructions. The storage medium 164 may be any electronic, magnetic, optical, or other physical storage device that stores executable instructions and/or data.

The processor 166 may be implemented as any suitable processing circuitry including, but not limited to at least one of a microcontroller, a microprocessor, a single processor, and a multiprocessor. The processor 166 may include at least one of a video scaler integrated circuit (IC), an embedded controller (EC), a central processing unit (CPU), a graphics processing unit (GPU), an accelerated processing unit (APU), an application specific integrated circuit (ASIC), field programmable gate arrays (FPGA), or the like, and may have a plurality of processing cores.

### Data Center Cluster Group 52

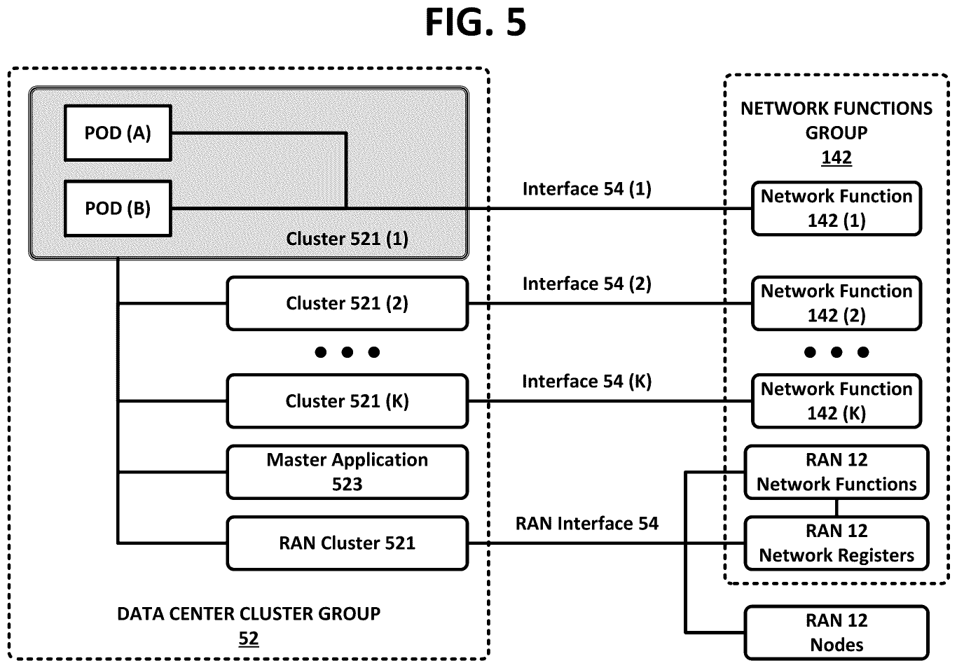

FIG. 5 is an example data center cluster group 52 that may exist in a data center. The data center may be the on-site data center 15. The data center may be a third-party data center 16. The components of the data center cluster group 52 may include individual clusters 521 and a master application 523.

The data center cluster group 52 may include clusters 521. Clusters 521 may include cluster 521 (1) through cluster 521 (K), with “K” being an integer number greater than 1. Clusters 521 may also include a radio access networks (RAN) cluster 521. Any of the clusters 521 in FIG. 5 may include a plurality of pods. Although only two pods (pod (A) and pod (B)) are illustrated in a single cluster 521, any of the clusters 521 having more than two pods is within the scope of the invention. Each pod in any of the clusters 521 is comprised of machine-readable instructions. The machine-readable instructions in any pod, when stored in a data center, are executable by the data center. Every pod in any of the clusters 521 is individually assigned a unique IP address. The unique IP address may permit each pod to communicate independently without any IP address conflicts.

As will be explained in detail, the master application 523 may comprise machine-readable instructions that manages the overall execution of the clusters 521 in the data center cluster group 52. The master application 523 is co-located along with the clusters 521 in the center cluster group 52.

As illustrated in FIG. 5, the network functions group 142 may include network function 142 (1) through network function 142 (K). The core network data center 14 in FIG. 3 may comprise the network functions group 142.

Interfaces 54 are also illustrated in FIG. 5. The interfaces 54 may comprise a single communication link between the clusters 521 and the network functions group 142. Alternatively, the interfaces 54 may comprise multiple communication links between the clusters 521 and the network functions group 142.

Interfaces 54 may include interface 54 (1) through interface 54 (K). As will be explained in detail, interface 54 (1) through interface 54 (K) in FIG. 5 may respectively connect a cluster 521 (1) through cluster 521 (K) to a corresponding network function 142 (1) through network function 142 (K).

The interfaces 54 in FIG. 5 may also include RAN interface 54. The RAN interface 54 may be a communication link between a RAN cluster 521 and any of the RAN 12 network functions. A RAN 12 network function is any network function in the network functions group 142 that may pertain to any RAN 12 (1) through RAN 12 (R) in the radio access system 12. The RAN 12 network functions may include, but are not limited to, the Access and Mobility Management Function (AMF), the User Plane Function (UPF), the Network Slice Selection Function (NSSF), and the Authentication Server Function (AUSF). The RAN interface 54 in FIG. 5 may also be a communication link between the RAN cluster 521 and the RAN 12 network registers. The RAN 12 network registers are the network registers in the network functions group 142 that may pertain to the radio access system 12. The RAN 12 network registers may include, but are not limited to, the 5G-Equipment Identity Register (5G-EIR). Although only one RAN cluster 521 is depicted in FIG. 5, the data center cluster group 52 having more than one RAN cluster 521 is within the scope of the invention.

A data center may establish the interfaces 54 in FIG. 5. The interfaces 54 may each comprise a hardware infrastructure that facilitates wired and/or wireless communication between data center cluster group 52 and the network functions group 142. The hardware infrastructure for any of the interfaces 54 may include cables, antennas, and physical other components that enable the transmission and reception of communications traffic between an on-site data center 15 and any core network data center CNDC 14 (1) through CNDC 14 (R). The hardware infrastructure for any of the interfaces 54 may include cables, antennas, and physical other components that enable the transmission and reception of communications traffic between any core network data center CNDC 14 (1) through CNDC 14 (R) and any third-party data center TPDC 16 (1) through TPDC 16 (R).

The data center cluster group 52 may apply signaling protocols when managing the communications traffic between the clusters 521 and the network functions group 142. Examples for the signaling protocols may include a Session Initiation Protocol (SIP), a Hypertext Transfer Protocol (HTTP), a DIAMETER protocol, and/or other signaling protocols. The clusters 521 may implement any of the protocols.

The Session Initiation Protocol (SIP) is a signaling protocol that defines the specific format for communications traffic related to video, voice, messaging, and other multimedia communications.

The Hypertext Transfer Protocol (HTTP) is a signaling protocol that defines the specific format for communications traffic between web browsers and web servers.

The DIAMETER protocol, which is a successor to the RADIUS (Remote Authentication Dial-In User Service) protocol, is a signaling protocol that defines the specific format for communications traffic related to authenticating users of the telecommunications network 10, authorizing user access to the telecommunications network 10, and collecting accounting information for billing and usage monitoring in the telecommunications network 10.

### Edge Computing In The Distributed Cloud Computing Environment

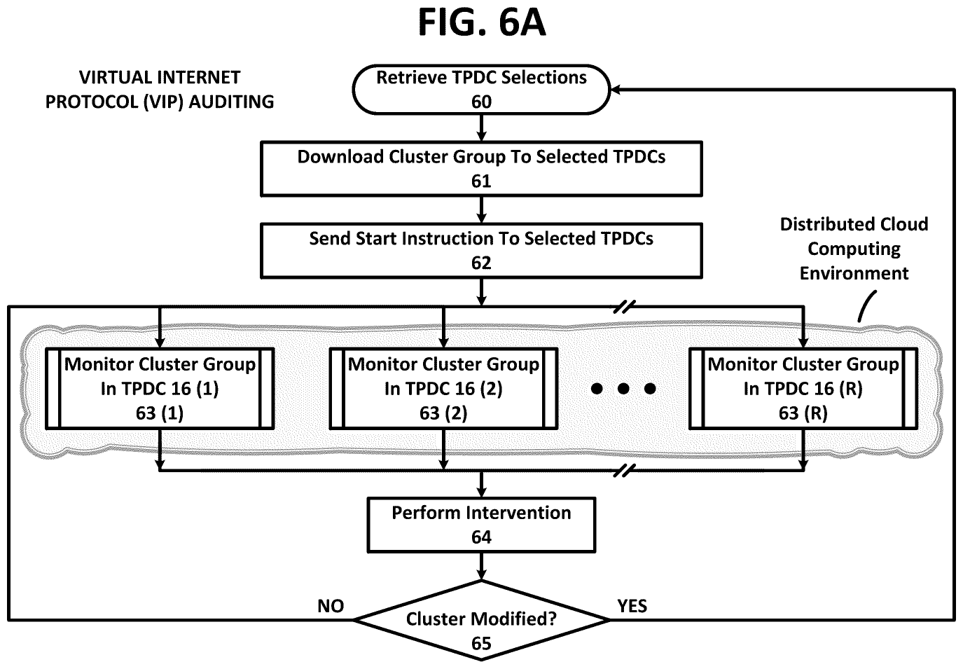

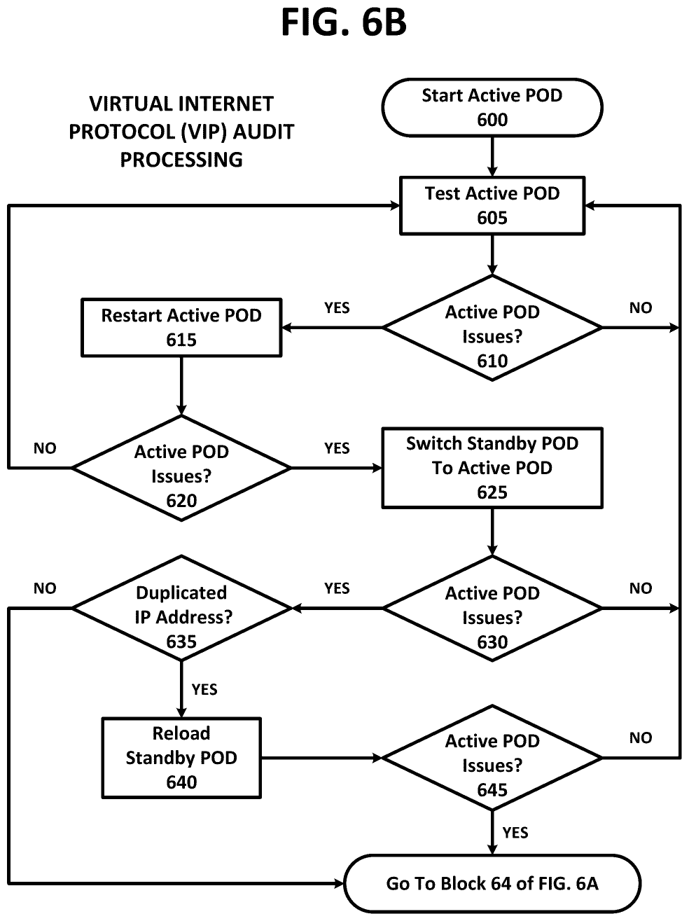

FIG. 6A is an example flowchart that illustrates the VIP Auditing performed by the on-site data center 15 in the distributed cloud computing environment of FIG. 4B.

A centralized computing environment may exist when a single data center such as the on-site data center 15 performs all of the processing tasks for the telecommunications network 10. Inadequate redundancy of critical components and network functions in a centralized computing environment could lead to interruptions throughout the telecommunications network 10 upon degradation or disruption of a single critical component or network function in the centralized computing environment. As an improved infrastructure for VIP Auditing, implementing redundancy of the critical components and network functions in the distributed cloud computing environment may be a critical factor in maintaining continuous VIP Auditing. In contrast to the centralized computing environment, processing in the distributed cloud computing environment of FIG. 4B may involve an allocation of the processing tasks for the telecommunications network 10 across the various third-party data centers TPDC 16 (1) through TPDC 16 (R).

In the distributed cloud computing environment, edge computing is when the VIP Auditing in FIG. 6A is performed in geographic areas near where the respective core network data centers 14 are located rather than the VIP Auditing in FIG. 6A being performed entirely at the on-site data center 15. Benefits of the VIP Auditing in FIG. 6A being performed as edge computing in the distributed cloud computing environment may include, but is not limited to, a reduction in overall bandwidth usage, a latency reduction, and a reduction in network communication disruptions.

Prior to the execution of the VIP Auditing in FIG. 6A and at any time during the execution of VIP Auditing, the interface 152 may receive selection instructions from the input device 158. When the interface 152 receives a selection instruction from the input device 158, the control circuitry 156 may control the memory 154 to store the selection instruction in the memory 154.

In block 60 of FIG. 6A, the control circuitry 156 may control the memory 154 to retrieve the selection instruction from the memory 154. The selection instruction may identify any of the third-party data centers TPDC 16 (1) through TPDC 16 (R) for the VIP Auditing.

For example, geographic region (1), geographic region (2), geographic region (6), and geographic region (R) are illustrated in the example of FIG. 4A. In FIG. 4A, radio access network RAN 12 (1) may communicate electronically with core network data center CNDC 14 (1), radio access network RAN 12 (2) may communicate electronically with core network data center CNDC 14 (2), and radio access network RAN 12 (R) may communicate electronically with core network data center CNDC 14 (R).

Also in the example of FIG. 4A, third-party data center TPDC 16 (1) is co-located in geographic region (1) along with core network data center CNDC 14 (1) and radio access network RAN 12 (1), third-party data center TPDC 16 (2) is co-located in geographic region (2) along with core network data center CNDC 14 (2) and radio access network RAN 12 (2), and third-party data center TPDC 16 (R) is co-located in geographic region (R) along with core network data center CNDC 14 (R) and radio access network RAN 12 (R).

In geographic region (6) of the example in FIG. 4A, a core network data center and a radio access network are absent from geographic region (6) while a third-party data center TPDC 16 (6) exists in geographic region (6). Accordingly, in the example of FIG. 4A, the selection instruction may identify TPDC 16 (1), TPDC 16 (2), and TPDC 16 (R) for the VIP Auditing of FIG. 6A. However, due to the absence of a core network data center and a radio access network in geographic region (6) in the example of FIG. 4A, TPDC 16 (6) is not designated in the selection instruction.

The control circuitry 156 may instruct the processor 166 to advance the VIP Auditing in FIG. 6A from block 60 to block 61. In block 61, the control circuitry 156 may control the memory 154 to retrieve data center cluster group 52. Pod (B) is a replica of pod (A) in each of the clusters 521. When retrieving the data center cluster group 52 from the memory 154, the control circuitry 156 may designate pod (A) in each of the clusters 521 as an active pod and may designate pod (B) in each of the clusters 521 as a standby pod. The control circuitry 156 may, when designating the pods, encrypt the data center cluster group 52 and control the interface 152 to download the encrypted data center cluster group 52 to any of the third-party data centers TPDC 16 (1) through TPDC 16 (R) identified in the selection instruction.

When controlling the interface 152 to download the encrypted data center cluster group 52, the control circuitry 156 may control the interface 152 to broadcast the data center cluster group 52 simultaneously to each of the third-party data centers TPDC 16 (1) through TPDC 16 (R) identified in the selection instruction. Due at least in part to the control circuitry 156 controlling the interface 152 to broadcast the data center cluster group 52, a human is unable to perform the VIP Auditing in FIG. 6A.

Alternatively, the control circuitry 156 may control the interface 152 to individually unicast the data center cluster group 52 to each of the third-party data centers TPDC 16 (1) through TPDC 16 (R) identified in the selection instruction when controlling the interface 152 to download the encrypted data center cluster group 52. Due at least in part to the control circuitry 156 controlling the interface 152 to unicast the data center cluster group 52, a human is unable to perform the VIP Auditing in FIG. 6A.

In block 61, the processor 166 in each third-party data center TPDC 16 (1) through TPDC 16 (R) identified in the selection instruction may obtain the master application 523 from their respective storage media 164. The master application 523 may include machine-readable instructions that, when executed by any the processor 166, causes the processor 166 to perform the VIP Audit processing of FIG. 6B. When downloading the data center cluster group 52 is completed, the control circuitry 156 may advance the VIP Auditing in FIG. 6A from block 61 to block 62.

In block 62, the control circuitry 156 may control the interface 152 to download, to each of the third-party data centers TPDC 16 (1) through TPDC 16 (R) identified in the selection instruction, a “start instruction” that commands any of the third-party data centers TPDC 16 (1) through TPDC 16 (R) that receives the data center cluster group 52 to initiate the VIP Auditing.

The control circuitry 156 may instruct the processor 166 to advance the data center processing of FIG. The control circuitry 156 may advance the VIP Auditing in FIG. 6A from block 62 to blocks 63 (1) through 63 (R), with “R” being an integer number greater than 1.

As will be explained in detail, an example of the distributed cloud computing environment FIG. 6A may include blocks 63 (1) through 63 (R). The various third-party data centers TPDC 16 (1) through TPDC 16 (R) may commence the VIP Audit processing in the distributed cloud computing environment upon receiving the data center cluster group 52 and the start instruction.

FIG. 6B illustrates the VIP Audit processing in the distributed cloud computing environment. The third-party data centers TPDC 16 (1) through TPDC 16 (R) identified in the selection instruction may, in blocks 63 (1) through 63 (R), simultaneously perform divided tasks in parallel with each other. Any one of the third-party data centers TPDC 16 (1) through TPDC 16 (R) may execute the VIP Audit processing in FIG. 6B concurrently and/or simultaneously with any other of the third-party data centers TPDC 16 (1) through TPDC 16 (R). Benefits of the VIP Audit processing in FIG. 6B in the distributed cloud computing environment may include, but is not limited to, improve overall system performance by distributing the workload among multiple third-party data centers 16, scalability of the VIP Audit processing in FIG. 6B, a reduction in overall bandwidth usage, a latency reduction, and a reduction in network communication disruptions.

The control circuitry 156 may instruct the processor 166 to advance the VIP Auditing in FIG. 6A from any of the blocks 63 (1) through 63 (R) to block 64, as will be explained in detail. In block 64, the control circuitry 156 may control the memory 154 to retrieve diagnostic scripts from the memory 154. Each diagnostic script is software that is designed to troubleshoot data paths throughout any of the radio access systems RAN 12 (1) through RAN 12 (R) and their respective core network data centers CNDC 14 (1) through CNDC 14 (R) and identify performance issues with any data path. The diagnostic script may undertake any repair actions to the data path. When retrieving the diagnostic scripts from the memory 154, the control circuitry 156 may execute the diagnostic scripts. The control circuitry 156 may instruct the processor 166 to advance the VIP Auditing in FIG. 6A from block 64 to block 65.

In block 65, the control circuitry 156 may determine whether any modification is introduced. A modification may include an alteration of any pod in the data center cluster group 52. A modification may include a modification of in the selection instruction. When the control circuitry 156 detects the modification (“YES”), the control circuitry 156 may instruct the processor 166 to advance the VIP Auditing in FIG. 6A from block 65 to block 60. When the control circuitry 156 detects an absence of the modification (“NO”), the control circuitry 156 may instruct the processor 166 to advance the VIP Auditing in FIG. 6A to blocks 63 (1) through 63 (R).

### Virtual Internet Protocol (VIP) Audit Processing

Each third-party data center TPDC 16 (1) through TPDC 16 (R) identified in the selection instruction may commence the VIP Audit processing in FIG. 6B upon the respective interface 162 in the third-party data center TPDC 16 (1) through TPDC 16 (R) receiving the data center cluster group 52 and the start instruction. The master application 523 may include machine-readable instructions that, when executed by a processor 166 for a third-party data center 16 in a geographic region, causes the processor 166 to perform the VIP Audit processing of FIG. 6B.

In block 600 of FIG. 6B, the interface 162 in the third-party data centers TPDC 16 (1) through TPDC 16 (R) to which the data center cluster group 52 is downloaded may receive the master application 523. The storage medium 164 may store the master application 523 when the interface 162 receives the master application 523. The processor 166 may extract an active pod and a standby pod from the storage medium 164 and assign virtual IP addresses to the active pod and the standby pod. Typically, the active pod is assigned a unique virtual IP address and the standby pod is assigned another unique virtual IP address. The virtual IP addresses may permit the active pod and the standby pod to communicate independently without any IP address conflicts. The processor 166 may execute the master application 523 when extracting the master application 523 from the storage medium 164. When the master application 523 is executed, the master application 523 may start the active pod. The master application 523 may instruct the processor 166 to advance the VIP Audit processing in FIG. 6B from block 600 to block 605.

In block 605 of FIG. 6B, the master application 523 may troubleshoot the active pod to identify any performance issues with the active pod. Performance issues may include a crash of the active pod and/or the active pod being unresponsive. Performance issues may include workload issues such as high CPU usage and/or memory usage. Performance issues may include network latency issues, packet loss issues, and/or other performance issues. The master application 523 may instruct the processor 166 to advance the VIP Audit processing in FIG. 6B from block 605 to block 610.

The processor 166, when executing the master application 523 in block 610, may detect a presence or an absence of any performance issue with the active pod. When processor 166 detects an absence of any performance issue with the active pod (“NO”), the master application 523 may instruct the processor 166 to advance the VIP Audit processing in FIG. 6B from block 610 to block 605. When the processor 166 detects a performance issue with the active pod (“YES”), the master application 523 may instruct the processor 166 to advance the VIP Audit processing in FIG. 6B from block 610 to block 615.

The processor 166, when executing the master application 523 in block 615, may halt the active pod then restart the active pod. The master application 523 may instruct the processor 166 to advance the VIP Audit processing in FIG. 6B from block 615 to block 620.

The processor 166, when executing the master application 523 in block 620, may troubleshoot the active pod to identify any performance issues with the active pod. When the processor 166 detects an absence of any performance issue with the active pod (“NO”), the master application 523 may instruct the processor 166 to advance the VIP Audit processing in FIG. 6B from block 620 to block 605. When the processor 166 detects a performance issue with the active pod (“YES”), the master application 523 may instruct the processor 166 to advance the VIP Audit processing in FIG. 6B from block 620 to block 625.

The processor 166, when executing the master application 523 in block 625, may halt the active pod and switch the standby pod to the active pod. When the standby pod is switched to the active pod, the previous active pod may become the newly-designated standby pod and the previous standby pod may become the newly-designated active pod. The master application 523 may instruct the processor 166 to advance the VIP Audit processing in FIG. 6B from block 625 to block 630.

The processor 166, when executing the master application 523 in block 630, may troubleshoot the newly-designated active pod to identify any performance issues with the newly-designated active pod. When the processor 166 detects an absence of any performance issue with the newly-designated active pod (“NO”), the master application 523 may instruct the processor 166 to advance the VIP Audit processing in FIG. 6B from block 630 to block 605. When the master application 523 detects a performance issue with the newly-designated active pod (“YES”), the master application 523 may instruct the processor 166 to advance the VIP Audit processing in FIG. 6B from block 630 to block 635.

The processor 166, when executing the master application 523 in block 635, may determine whether or not an IP address conflict exists between the newly-designated active pod the newly-designated standby pod. An IP address conflict may exist when the virtual IP address for the newly-designated active pod and the virtual IP address for the newly-designated standby pod are duplicate IP addresses. The IP address conflict, when in existence, may cause operational issues. The operational issues may degrade the overall performance of the cluster 521 containing the newly-designated active pod the newly-designated standby pod. When the processor 166 detects an absence of an IP address conflict (“NO”), the master application 523 may instruct the processor 166 to advance the VIP Audit processing in FIG. 6B from block 635 to block 64 in FIG. 6A. When the processor 166 detects an IP address conflict (“YES”), the master application 523 may instruct the processor 166 to advance the VIP Audit processing in FIG. 6B from block 635 to block 640.

The processor 166, when executing the master application 523 in block 640, may delete the newly-designated standby pod. Deleting the newly-designated standby pod may remove the newly-designated standby pod from the cluster 521 containing the newly-designated standby pod. The processor 166, when deleting the newly-designated standby pod, may load a copy of the newly-designated active pod into the cluster 521 that contains the newly-designated active pod. The copy of the newly-designated active pod may become the newly-designated standby pod. The third-party data center TPDC 16 (1) through TPDC 16 (R) on which the active pod and the standby pod reside may assign another virtual IP addresses to the copy of the newly-designated active pod. The master application 523 may instruct the processor 166 to advance the VIP Audit processing in FIG. 6B from block 640 to block 645.

The processor 166, when executing the master application 523 in block 645, may troubleshoot the newly-designated active pod to identify any performance issues with the newly-designated active pod. When the processor 166 detects an absence of any performance issue with the newly-designated active pod (“NO”), the master application 523 may instruct the processor 166 to advance the VIP Audit processing in FIG. 6B from block 645 to block 605. When the processor 166 detects the presence of a performance issue with the newly-designated active pod (“YES”), the master application 523 may instruct the processor 166 to advance the VIP Audit processing in FIG. 6B from block 645 to block 64 in FIG. 6A.

In some examples, aspects of the technology, including computerized implementations of methods according to the technology, may be implemented as a system, method, apparatus, or article of manufacture using standard programming or engineering techniques to produce software, firmware, hardware, or any combination thereof to control a processor, also referred to as an electronic processor, (e.g., a serial or parallel processor chip or specialized processor chip, a single-or multi-core chip, a microprocessor, a field programmable gate array, any variety of combinations of a control unit, arithmetic logic unit, and processor register, and so on), a computer (e.g., a processor operatively coupled to a memory), or another electronically operated controller to implement aspects detailed herein.

Accordingly, for example, examples of the technology may be implemented as a set of instructions, tangibly embodied on a non-transitory computer-readable media, such that a processor may implement the instructions based upon reading the instructions from the computer-readable media. Some examples of the technology may include (or utilize) a control device such as, e.g., an automation device, a special purpose or programmable computer including various computer hardware, software, firmware, and so on, consistent with the discussion herein. As specific examples, a control device may include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.).

Certain operations of methods according to the technology, or of systems executing those methods, may be represented schematically in the figures or otherwise discussed herein. Unless otherwise specified or limited, representation in the figures of particular operations in particular spatial order may not necessarily require those operations to be executed in a particular sequence corresponding to the particular spatial order. Correspondingly, certain operations represented in the figures, or otherwise disclosed herein, may be executed in different orders than are expressly illustrated or described, as appropriate for particular examples of the technology. Further, in some examples, certain operations may be executed in parallel or partially in parallel, including by dedicated parallel processing devices, or separate computing devices configured to interoperate as part of a large system.

As used herein in the context of computer implementation, unless otherwise specified or limited, the terms “component,” “system,” “module,” “block,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer may be a component. A component (or system, module, and so on) may reside within a process or thread of execution, may be localized on one computer, may be distributed between two or more computers or other processor devices, or may be included within another component (or system, module, and so on).

Also as used herein, unless otherwise limited or defined, “or” indicates a non-exclusive list of components or operations that may be present in any variety of combinations, rather than an exclusive list of components that may be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as, e.g., “either,” “only one of,” or “exactly one of.” Further, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more Band one or more C; one or more A and one or more C; and one or more of each of A, B, and C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; Band C; A and C; and A, B, and C. In general, the term “or” as used herein only indicates exclusive alternatives (e.g., “one or the other but not both”) when preceded by terms of exclusivity, such as, e.g., “either,” “only one of,” or “exactly one of.”

In the description above and the claims below, the term “connected” may refer to a physical connection or a logical connection. A physical connection indicates that at least two devices or systems co-operate, communicate, or interact with each other, and are in direct physical or electrical contact with each other. For example, two devices are physically connected via an electrical cable. A logical connection indicates that at least two devices or systems co-operate, communicate, or interact with each other, but may or may not be in direct physical or electrical contact with each other. Throughout the description and claims, the term “coupled” may be used to show a logical connection that is not necessarily a physical connection. “Co-operation,” “the communication,” “interaction” and their variations include at least one of: (i) transmitting of information to a device or system; or (ii) receiving of information by a device or system.

Any mark, if referenced herein, may be common law or registered trademarks of third parties affiliated or unaffiliated with the applicant or the assignee. Use of these marks is by way of example and shall not be construed as descriptive or to limit the scope of disclosed or claimed embodiments to material associated only with such marks.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Throughout the application, ordinal numbers (e.g., first, second, third, etc.) may be used as an adjective for an element (i.e., any noun in the application). Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section.

The use of ordinal numbers is not to imply or create any particular ordering of the elements nor to limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements. Thus, a first member, component, region, layer, or section referred to in examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application.

Unless otherwise indicated, like parts and method steps are referred to with like reference numerals.

Although the present technology has been described by referring to certain examples, workers skilled in the art will recognize that changes may be made in form and detail without departing from the scope of the discussion.

What is claimed is:

1. An electronic apparatus comprising:
an interface configured to electronically receive a cluster of software from a remote data center, the cluster of software having an active pod and a standby pod;
a storage medium configured to store the cluster of software when the interface receives the cluster of software, the cluster of software having a master application; and
a processor configured to assign, when extracting the active pod and the standby pod from the storage medium, a virtual IP address to the active pod and a virtual IP address to the standby pod,
wherein the processor is configured to execute, when extracting the master application from the storage medium, the master application to cause the processor to:
determine whether or not an IP address conflict exists between the virtual IP address of the active pod and the virtual IP address of the standby pod, and
reload, when the IP address conflict exists, the standby pod.

2. The electronic apparatus according to claim 1, wherein the IP address conflict is when the virtual IP address for the active pod and the virtual IP address for the standby pod are duplicate IP addresses.

3. The electronic apparatus according to claim 1, wherein the processor is configured to:
detect, when the processor executes the master application, a presence or an absence of a performance issue with the active pod.

4. The electronic apparatus according to claim 3, wherein the processor is configured to:
stop, when the when the processor detects the presence of the performance issue with the active pod, the active pod then restart the active pod.

5. The electronic apparatus according to claim 3, wherein the processor is configured to:
switch, when the when the processor detects the presence of the performance issue with the active pod, the standby pod to the active pod.

6. A system comprising:
the electronic apparatus according to claim 1; and
the remote data center,
wherein the remote data center is configured to broadcast the cluster of software simultaneously to a plurality of data centers.

7. The system according to claim 6, wherein the electronic apparatus is one of the data centers.

8. The system according to claim 6, wherein the remote data center is configured to output, to the electronic apparatus, a start instruction that commands the electronic apparatus to execute the master application.

9. A method comprising:
receiving, electronically by an interface, a cluster of software from a remote data center;
storing, to a storage medium, the cluster of software when the interface receives the cluster of software;
extracting, from the storage medium by a processor, the cluster of software having an active pod and a standby pod;
assigning, by the processor when extracting the active pod and the standby pod from the storage medium, a virtual IP address to the active pod and a virtual IP address to the standby pod;
extracting, from the storage medium by the processor, a master application in the cluster of software; and
executing, by the processor when extracting the master application, the master application to cause the processor to:
determine whether or not an IP address conflict exists between the virtual IP address of the active pod and the virtual IP address of the standby pod, and
reload, when the IP address conflict exists, the standby pod.

10. The method according to claim 9, wherein the IP address conflict is when the virtual IP address for the active pod and the virtual IP address for the standby pod are duplicate IP addresses.

11. The method according to claim 9, further comprising:
detecting, by the processor when the processor executes the master application, a presence or an absence of a performance issue with the active pod.

12. The method according to claim 11, further comprising:
halting, by the processor when the when the processor detects the presence of the performance issue with the active pod, the active pod then restart the active pod.

13. The method according to claim 11, further comprising:
switching, by the processor when the when the processor detects the presence of the performance issue with the active pod, the standby pod to the active pod.

14. A non-transitory machine-readable medium including instructions, when executed by a processor, cause the processor to:
extract, from a storage medium, a cluster having an active pod and a standby pod;
assign, when extracting the active pod and the standby pod, a virtual IP address to the active pod and a virtual IP address to the standby pod;
determine whether or not an IP address conflict exists between the virtual IP address of the active pod and the virtual IP address of the standby pod; and
reload the standby pod when the IP address conflict exists.

15. The non-transitory machine-readable medium according to claim 15, wherein the IP address conflict is when the virtual IP address for the active pod and the virtual IP address for the standby pod are duplicate IP addresses.

16. The non-transitory machine-readable medium according to claim 15, wherein the non-transitory machine-readable medium includes instructions, when executed by a processor, cause the processor to:
detect a presence or an absence of a performance issue with the active pod.

17. The non-transitory machine-readable medium according to claim 16, wherein the non-transitory machine-readable medium includes instructions, when executed by a processor, cause the processor to:
halt, when the when the processor detects the presence of the performance issue with the active pod, the active pod then restart the active pod.

18. The non-transitory machine-readable medium according to claim 16, wherein the non-transitory machine-readable medium includes instructions, when executed by a processor, cause the processor to:
switch, when the when the processor detects the presence of the performance issue with the active pod, the standby pod to the active pod.
